(19) United States
(12) Patent Application Publication
(10) Pub. No.: US 2014/0192458 A1
(43) Pub. Date: Jul. 10, 2014

(54) POWER DISTRIBUTION SYSTEMS AND METHODS OF OPERATING A POWER DISTRIBUTION SYSTEM INCLUDING ARC FLASH DETECTION

(71) Applicant: GENERAL ELECTRIC COMPANY, Schenectady, NY (US)

(72) Inventor: Marcelo Esteban Valdes, Burlington, CT (US)

(73) Assignee: General Electric Company, Schenectady, NY (US)

(21) Appl. No.: 13/734,431

(22) Filed: Jan. 4, 2013

(51) Int. Cl. H01H 83/00

(52) U.S. Cl. CPC H01H 83/00
USPC 361/626

(57) ABSTRACT

An arc flash relay system is described for use in a power distribution system including an arc flash sensor, a first circuit protection device, and a second circuit protection device. The arc flash relay system includes a first input configured to receive a detection signal from the arc flash sensor, a second input configured to receive a blocking signal from the first circuit protection device, and a controller. The controller is configured to determine that an arc flash has occurred based, at least in part, on the detection signal. The controller activates the second circuit protection device in response to the determination that an arc flash has occurred when the controller is not receiving the blocking signal, and delays activation of the second circuit protection device in response to the determination that an arc flash has occurred when the controller is receiving the blocking signal.

### BACKGROUND

The present application relates generally to power systems and, more particularly, to power distribution systems and methods of operating a power distribution system.

Some known electrical distribution systems include switchgear including circuit breakers that that are each coupled to one or more loads. The circuit breakers typically include a trip unit that controls the circuit breakers based upon sensed current flowing through the circuit breakers. More specifically, the trip unit causes current flowing through the circuit breaker to be interrupted if the current is outside of acceptable conditions. Air interrupter circuit breakers operate in air and create an arc between two contacts when interrupting the current flowing through the circuit breaker.

Electric power circuits and switchgear generally include conductors that are separated by insulation, such as air, or gas or solid dielectrics. Under certain conditions, such as when the conductors are positioned too closely together or a voltage between the conductors exceeds the insulative properties of the insulation, an arc can occur. An arc flash is caused by a rapid release of energy due to a fault between two phase conductors, between a phase conductor and a neutral conductor, or between a phase conductor and a ground point. Arc flash temperatures can reach or exceed 20,000° C., which can vaporize the conductors and adjacent equipment. In addition, an arc flash can release significant energy in the form of heat, intense light, pressure waves, and/or sound waves, sufficient to damage the conductors and adjacent equipment. Moreover, the released energy can cause significant injuries to humans in the vicinity of an arc fault event.

Some known distribution systems include an arc flash detection and/or mitigation system to facilitate detecting and/or mitigating an arc flash event. Some of the known systems rely on light, sound, and/or pressure sensors to detect the light, sound, and/or pressure generated by an arc flash event. In power distribution systems that include air interrupter circuit breakers, the arc created when the circuit breaker trips causes some detection systems to indicate that an arc fault is occurring. The erroneous detection may result in activation of additional protection or mitigation devices, tripping of additional circuit breakers, and other unnecessary actions.

### BRIEF DESCRIPTION

In one aspect, a power distribution system is provided. The power distribution system includes a first distribution bus disposed within a volume defined by an enclosure, an arc flash sensor configured to detect an arc within the volume and generate a detection signal, and an arc flash relay system communicatively coupled to the arc flash sensor. The arc flash relay system includes a controller configured to determine that an arc flash has occurred based, at least in part, on the detection signal. The power distribution system includes a first circuit protection device operatively disposed within the volume. The first circuit protection device includes a trip mechanism configured to interrupt a current flowing through the first distribution bus and a trip unit operatively coupled to the trip mechanism. The trip unit is configured to determine when a current on the first distribution bus exceeds a protection threshold, and output a blocking signal to the arc flash relay system and output a trip signal to the trip mechanism upon determining that a current on said first distribution bus exceeds the protection threshold.

In another aspect, an arc flash relay system for use in a power distribution system including an arc flash sensor, a first circuit protection device, and a second circuit protection device is disclosed. The arc flash relay system includes a first input configured to receive a detection signal from the arc flash sensor, a second input configured to receive a blocking signal from the first circuit protection device, and a controller. The controller is configured to determine that an arc flash has occurred based, at least in part, on the detection signal, activate the second circuit protection device in response to the determination that an arc has occurred when the controller is not receiving the blocking signal, and delay activation of the second circuit protection device in response to the determination that an arc flash has occurred when the controller is receiving the blocking signal.

In yet another aspect, a method for use by an arc flash relay system in a power distribution system including a first circuit protection device configured to output a blocking signal, and a second circuit protection device configured to provide arc flash protection is disclosed. The method includes determining that an arc flash has occurred within a volume occupied by the power distribution system. The second circuit protection device is activated in response to the determination that an arc flash has occurred when the arc flash relay system is not receiving the blocking signal from the first circuit protection device. Activation of the second circuit protection device in response to the determination that an arc flash has occurred is delayed when the arc flash relay system is receiving the blocking signal from the first circuit protection device.

### BRIEF DESCRIPTION OF THE DRAWINGS

FIG. 1 is a schematic block diagram of an exemplary power distribution system.

FIGS. 2A and 2B are a logic flow diagram for operation of the power distribution system shown in FIG. 1.

FIG. 3 is a simplified block diagram of an exemplary arc flash relay system for use the power distribution system shown in FIG. 1.

FIG. 4 is a simplified block diagram of another exemplary arc flash relay system for use the power distribution system shown in FIG. 1.

FIG. 5 is a simplified block diagram of another exemplary arc flash relay system for use the power distribution system shown in FIG. 1.

FIG. 6 is an exemplary logic flow diagram for operation of the arc flash relay system shown in FIG. 5.

FIG. 7 is another logic flow diagram for operation of the arc flash relay system shown in FIG. 5.

### DETAILED DESCRIPTION

Exemplary embodiments of power distribution systems and methods of operating a power distribution system that includes arc flash detection are described herein. The exemplary power distribution systems integrate arc flash detection and protection into a distribution system while limiting nuisance tripping that may occur when an arc caused by a tripping breaker is detected as an arc flash and triggers arc flash protection of the system.

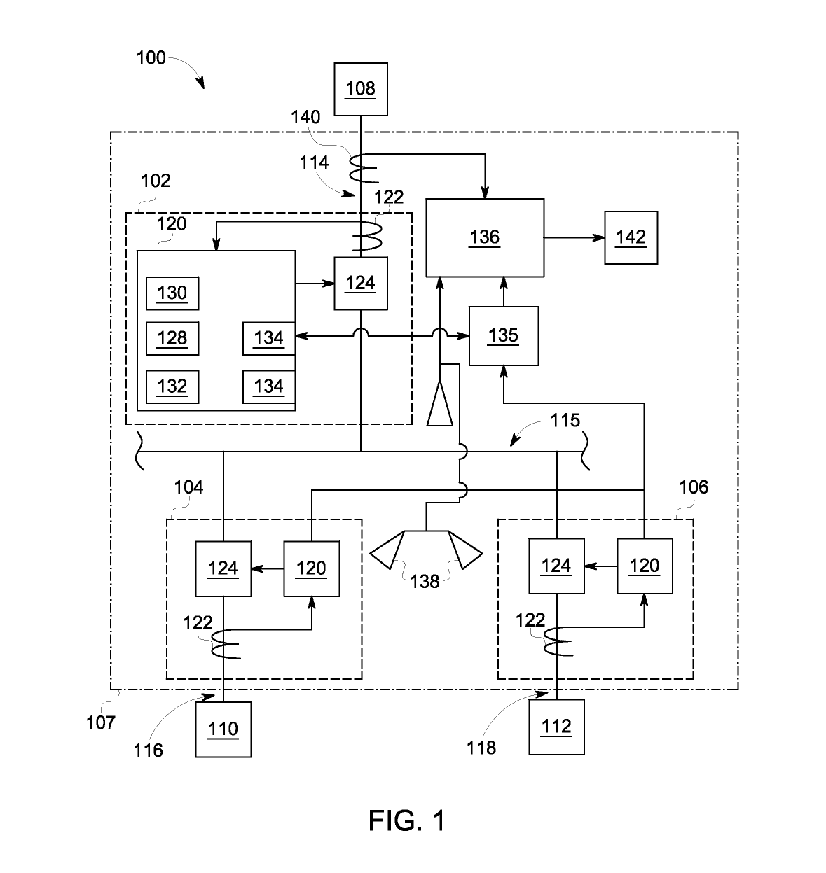

FIG. 1 is a schematic block diagram of a portion of an exemplary power distribution system 100. Power distribution system 100 includes a plurality of circuit protection devices 102, 104, and 106. In other embodiments, power distribution system 100 includes more or fewer circuit protection devices 102, 104, and 106. In the exemplary embodiment, circuit protection devices 102, 104, and 106 are positioned within one or more switchgear units (not shown). In other embodiments, circuit protection devices 102, 104, and 106 are positioned in any other suitable location and/or enclosure. The portion of power distribution system 100 illustrated in FIG. 1 is disposed within a volume 107 of space that may be a cavity defined, for example, by an enclosure in which it is housed.

Each circuit protection device 102, 104, and 106 is configured to programmably control a delivery of power from one or more electrical power sources 108 to one or more of loads 110 and 112. Electrical power sources 108 may include, for example, one or more generators or other devices that provide electrical current (and resulting electrical power) to loads 110 and 112. The electrical current is transmitted from sources 108 to loads 110 and 112 through electrical distribution lines or busses 114, 116, and 118 coupled to circuit protection devices 102, 104, and 106, respectively. Loads 110 and 112 may include, but are not limited to only including, machinery, motors, lighting, and/or other electrical and mechanical equipment of a manufacturing or power generation or distribution facility.

In the exemplary embodiment, circuit protection devices 102, 104, and 106 are circuit breakers. Alternatively, circuit protection devices 102, 104, and 106 may be any other device that enables power distribution system 100 to function as described herein. Each circuit protection device 102, 104, and 106 includes a trip unit 120 operatively coupled to a sensor 122 and a trip mechanism 124. Trip units 120, in the exemplary embodiment, are electronic trip units (ETUs), each of which includes a processor 128 coupled to a memory 130 and a display device 132. In other embodiments, trip units 120 may be any other suitable type of trip unit. In some embodiments, one or more of circuit protection devices 102, 104, and 106 includes a different type of trip unit 120 and/or is a different type of circuit protection device than at least one other of circuit protection devices 102, 104, and 106. In still other embodiments, one or more circuit protection devices 102, 104, and 106 do not include an ETU and are controlled, instead, by a central controller (not shown) configured to operate its controlled circuit protection devices 102, 104, and/or 106 as described herein.

Sensor 122, in the exemplary embodiment, is a current sensor, such as a current transformer, a Rogowski coil, a Hall-effect sensor, and/or a shunt that measures a current flowing through trip mechanism 124 and/or circuit protection device 102, 104, and 106. Alternatively, sensor 122 may include any other sensor that enables power distribution system 100 to function as described herein. Each sensor 122 generates a signal representative of the measured or detected current (hereinafter referred to as “current signal”) flowing through an associated trip mechanism 124 and/or circuit protection device 102, 104, and 106. In addition, each sensor 122 transmits the current signal to processor 128 associated with, or coupled to, trip mechanism 124. Each processor 128 is programmed to activate trip mechanism 124 to interrupt a current provided to load 110 or 112 if the current signal, and/or the current represented by the current signal, exceeds a current threshold.

Trip mechanism 124 includes, for example, one or more circuit breaker devices. Exemplary circuit breaker devices include, for example, circuit switches, contact arms, and/or circuit interrupters that interrupt current flowing through the circuit breaker device to a load, such as load 110 or 112, coupled to the circuit breaker device. In the exemplary embodiment, at least one of circuit protection devices 102, 104, and 106 is an air interrupter. When an air interrupter circuit protection device 102, 104, or 106 interrupts current, an arc is created between its contacts.

Each processor 128 controls the operation of one circuit protection device 102, 104, or 106 and gathers measured operating condition data, such as data representative of a current measurement (also referred to herein as “current data”), from sensor 122 associated with trip mechanism 124 coupled to processor 128. Processor 128 stores the current data in memory. Based at least in part on the current data, processor 128 determines when the current on its associated distribution bus exceeds a protection threshold and outputs a trip signal to trip mechanism 124 upon determining that the current exceeds the protection threshold. It should be understood that the term “processor” refers generally to any programmable system including systems and microcontrollers, reduced instruction set circuits (RISC), application specific integrated circuits (ASIC), programmable logic circuits, and any other circuit or processor capable of executing the functions described herein. The above examples are exemplary only, and thus are not intended to limit in any way the definition and/or meaning of the term “processor.”

Memory 130 stores program code and instructions, executable by processor 128, to control its associated circuit protection device 102, 104, or 106. Memory 130 may include, but is not limited to only include, non-volatile RAM (NVRAM), magnetic RAM (MRAM), ferroelectric RAM (FeRAM), read only memory (ROM), flash memory and/or Electrically Erasable Programmable Read Only Memory (EEPROM). Any other suitable magnetic, optical and/or semiconductor memory, by itself or in combination with other forms of memory, may be included in memory 130. Memory 130 may also be, or include, a detachable or removable memory, including, but not limited to, a suitable cartridge, disk, CD ROM, DVD or USB memory.

In an exemplary embodiment, display device 132 includes one or more light-emitting diodes (LEDs) that indicate a status of its circuit protection device 102, 104, or 106, and/or trip mechanism 124. For example, processor 128 may activate one or more components (e.g., LEDs) of display device 132 to indicate that the associated circuit protection device 102, 104, or 106, and/or trip mechanism 124 is active and/or operating normally, that a fault or failure has occurred, and/or any other status of trip mechanism 124 and/or circuit protection device 102, 104, and 106. In other embodiments, one or more of circuit protection devices 102, 104, and 106 do not include display device 132.

In the exemplary embodiment, circuit protection devices 102, 104, and 106 are arranged in a hierarchy to provide different levels of protection and monitoring to power distribution system 100. First circuit protection device 102 is coupled to first distribution bus 114, also referred to as a source or line bus, to receive current from electrical power source 108. Power is supplied from bus 114 to second distribution bus 115, also sometimes referred to as a main bus, downstream of first circuit protection device 102. Third distribution bus 116 and fourth distribution bus 118, sometimes referred to as load buses, receive electrical power from main bus 115 for delivery to loads 110 and 112, respectively. Second circuit protection device 104 is coupled to bus 116 and third circuit protection device 106 is coupled to bus 118. As used herein, the term “downstream” refers to a direction of current flow, for example, from electrical power source 108 towards loads 110 and 112. The term “upstream” refers to a direction of current flow, for example, from load 110 and 112 towards electrical power source 108. Each circuit protection device 102, 104, and 106 provides protection for each downstream bus 114, 115, 116, and/or 118. Thus, for example, circuit protection device 102 provides protection for buses 114, 115, 116, and 118, while circuit protection device 104 provides protection for bus 116.

While FIG. 1 illustrates three circuit protection devices 102, 104, and 106 and four buses 114, 115, 116, and 118 arranged in two tiers, it should be recognized that any suitable number of circuit protection devices 102, 104, and 106 may be arranged with any suitable number of buses 114, 115, 116, and 118 in any suitable number of tiers to enable power distribution system 100 to function as described herein. For example, it should be recognized that one or more additional tiers, buses 114, 115, 116, and 118, and/or circuit protection devices 102, 104, and 106 may be disposed between electrical power source 108 and circuit protection device 102. Additionally or alternatively, one or more additional tiers, buses 114, 115, 116, and 118, and/or circuit protection devices 102, 104, and 106 may be disposed between loads 110 and 112 and circuit protection devices 104 and/or 106 in some embodiments.

Each trip unit 120 includes one or more ports 134 configured to receive and or transmit signals, for example to/from other trip units 120. Ports 134 may include discrete input ports, discrete output ports, and/or bidirectional input/output ports. In the exemplary embodiment, restraining and/or blocking signals are communicated between circuit protection devices 102, 104, and 106, via ports 134, to coordinate operation of circuit protection devices 102, 104, and 106 as part of a zone selective interlocking (ZSI) scheme. The ZSI scheme may be any suitable ZSI scheme. In an example ZSI scheme, circuit protection devices output restraining signals to an upstream circuit protection device, i.e., located in a tier above the circuit protection device issuing the restraining signal, in order to prevent the upstream device from tripping before the device issuing the restraining signal. For example, when protection device 104 detects a current greater than a protective threshold, its trip unit 120 outputs a restraining signal to upstream protection device 102. Protection device 102 is configured to operate in a restrained mode, e.g., its response times are increased, upon receiving a retraining signal. If protection device 104 detects a current greater than an instantaneous threshold, which is greater than the protective threshold, its trip unit 120 issues a trip signal to its trip mechanism 124.

In the exemplary embodiment, system 100 includes a ZSI module 135 that receives and distributes blocking signals to the appropriate recipient(s) of the blocking signals. Circuit protection devices 104 and 106 transmit their blocking signals to ZSI module 135, and ZSI module 135 provides the blocking signal to circuit protection device 102. In the exemplary embodiment, ZSI module 135 also outputs blocking signals to an arc fault relay system (AFRS) 136, which is described below. In other embodiments, any other suitable signal distribution scheme may be used. For example, some embodiments do not include ZSI module 135, and blocking signals are directly communicated from circuit protection devices 104 and 106 to the circuit protection device 102 and/or AFRS 136. In still other embodiments, system 100 includes more than one ZSI module 136.

AFRS 136 is configured to determine when arc flashes occur within volume 107 and facilitate mitigation of the arc flashes. AFRS is communicatively coupled to arc flash sensors 138. Although three arc flash sensors 138 are shown in FIG. 1, in other embodiments system 100 includes more or fewer arc flash sensors 138. Each arc flash sensor 138 is configured to detect an arc within volume 107 and generate a detection signal. In the exemplary embodiment, arc flash sensors 138 are light sensors capable of detecting the light generated by an electrical arc. In other embodiments, arc flash sensors 138 may include sound sensors to detect the sound generated by an electrical arc, pressure sensors to detect a pressure wave generated by an arc, or any other sensors suitable for detecting an electrical arc. Moreover, in some embodiments, sensors 138 include a combination of types of sensors capable of detecting an arc flash. In the exemplary embodiment, when an arc flash sensor 138 detects a light exceeding a threshold value, it provides a detection signal to AFRS 136. A current sensor 140 generates a signal representative of the measured or detected current (hereinafter referred to as “current signal”) flowing through distribution bus 114 and the current signal is provided to AFRS 136. In the exemplary embodiment, AFRS 136 determines an arc flash has occurred within volume 107 based on the detection signal with confirmation from the current signal. When an arc flash occurs, overcurrent conditions will exist in the system and the arc flash will produce light, sound, and pressure. Thus, when the detection signal from one or more of arc flash sensors 138 indicates an arc has occurred (e.g., the detected light exceeds a threshold) and the current signal from sensor 140 indicates that the current through bus 114 exceeds a predetermined threshold, AFRS 136 determines that an arc flash has occurred/is occurring. In some embodiments, confirmation of an arc flash determination based on the current signal is omitted and/or optional. Some embodiments include, additionally or alternatively, arc flash determination confirmation based on sound and/or pressure signals from sound and/or pressure sensors. In some embodiments AFRS 136 determines an arc flash has occurred based solely on the detection signal from arc flash sensor(s) 138. Moreover, as will be described in more detail below, AFRS 136 may be selectively operated in more than one operational mode, and the basis for determining and/or confirming that an arc flash has occurred may vary depending on the selected operational mode.

Upon determining that an arc flash has occurred, AFRS 136 acts to mitigate the suspected arc flash. In the exemplary embodiment, AFRS 136 outputs a trip signal to a circuit protection device 142. In the exemplary embodiment, circuit protection device 142 is an arc flash mitigation device, such as an arc containment device, a crowbar, etc. Arc containment devices include, for example, a containment assembly, a plurality of electrodes, a plasma gun, and a trigger circuit that causes the plasma gun to emit ablative plasma into a gap between the electrodes in order to divert energy into the containment assembly from an arc or other electrical fault that is detected on the circuit. The trip signal activates (also referred to as tripping or triggering) circuit protection device 142, and circuit protection device 142 operates to divert energy to mitigate the arc flash. In the exemplary embodiment, circuit protection device 142 is separate from AFRS 136. In other embodiments, as will be described in more detail below, AFRS 136 includes circuit protection device 142. In some embodiments, circuit protection device 142 is a circuit breaker (not shown) or other suitable circuit interrupter upstream from the portion of system 100 within volume 107.

In the exemplary embodiment, AFRS 136 also outputs a trip signal to circuit protection device 102, and circuit protection device 102 interrupts current flowing through bus 114. In some embodiments, the trip signal is provided to circuit protection device 102 only, while in other embodiments the trip signal is provided only to circuit protection device 142. In still other embodiments, AFRS 136 sends a trip signal, alternatively or additionally, to a circuit breaker (not shown) outside of volume 107. Thus, if the specific location within volume 107 of the suspected arc flash is unknown or the location of the arc flash is on main bus 114, AFRS 136 may send a trip signal to a circuit breaker (not shown) outside of volume 107 and upstream from circuit protection device 102. In embodiments in which AFRS 136 outputs the trip signal to a circuit breaker, whether in addition to or as an alternate to sending the signal to circuit protection device 142, AFRS outputs the trip signal to a circuit breaker located upstream from the location of the suspected arc flash.

When one of circuit protection devices 102, 104, or 106 detects an overcurrent condition and determines to trip its trip mechanism 124, its trip unit 120 outputs a blocking signal to AFRS 136 via ZSI module 135. In the exemplary embodiment, trip unit 120 outputs the blocking signal upon detecting the overcurrent condition. In other embodiments, trip unit 120 outputs the blocking signal at the same time that it issues a trip command to trip mechanism 124. The blocking signal informs AFRS 136 that circuit protection device 102, 104, or 106 is about to trip its trip mechanism 124. When the contacts (not shown) of trip mechanism 124 separate and produce an arc, arc flash sensor 138 will detect the arc. Because an overcurrent condition exists, current sensor 140 will also provide a current signal to AFRS 136 indicating that the overcurrent condition exists. Thus, AFRS 136 determines that an arc flash has occurred. Because AFRS 136 has received the blocking signal from circuit protection device 102, 104, or 106, AFRS 136 knows that the arc flash is likely an arc caused by the separation of the contacts of trip mechanism 124. AFRS 136 is configured to operate in a restrained operational mode in response to the received blocking signal. In the exemplary embodiment, AFRS 136 delays output of a trip signal for a determined period of time. The determined period of time is a period of time longer than the time required for trip mechanism 124 of the circuit protection device 102, 104, or 106 that issued the blocking signal to complete its interruption of current. If AFRS 136 still detects an arc flash after the determined period time has passed, AFRS 136 acts to mitigate the arc flash. In the exemplary embodiment, the determined period of time is a predetermined period of time based, at least in part, on the mechanical characteristics of each particular circuit protection device 102, 104, and 106. In other embodiments, the determined period of time is defined by the circuit protection device 102, 104, or 106 outputting the blocking signal. In such embodiments, AFRS 136 delays response to a suspected arc flash for as long as it receives the blocking signal

In the exemplary embodiment, AFRS 136 is selectively operable in a normal mode and a maintenance mode. In the normal operational mode, AFRS 136 determines that an arc flash has occurred based on the trip signal from arc flash sensor(s) 138 and the current signal from current sensor 140. In the maintenance mode, AFRS 136 determines that an arc flash has occurred based solely on the trip signal from arc flash sensor(s) 138. Maintenance mode is commonly selected when a person is in the vicinity of system 100 and nuisance trips of circuit protection devices 102, 104, 106 are preferred over delayed, but more accurate, protection. The effect of the blocking signal on AFRS 136 also varies depending on the mode in which AFRS 136 is operating. When AFRS 136 is in the normal operational mode, AFRS 136 operates as described above. AFRS 136 is configured to ignore all blocking signals when operating in maintenance mode. Thus, when AFRS 136 is in the maintenance mode, AFRS outputs the trip signal to activate circuit protection device 142 without regard to the blocking signal.

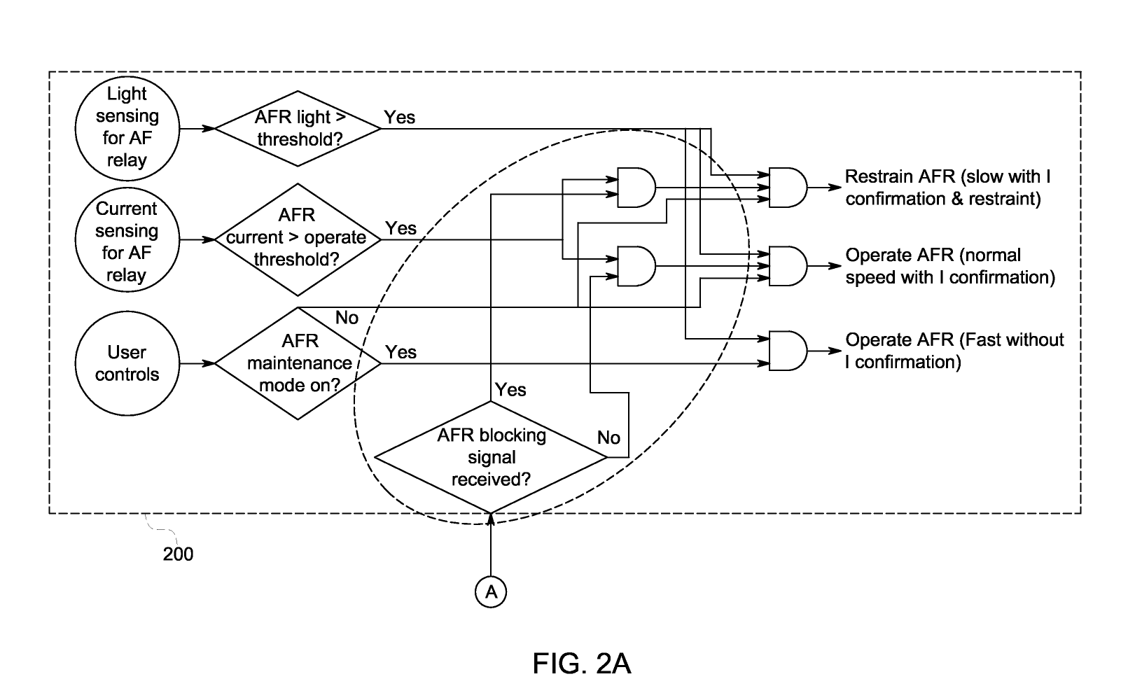

FIGS. 2A and 2B are an exemplary logical flow diagram for system 100. The logical decisions are grouped according to which element of system 100 performs the decision. Portion 200 is performed by AFRS 136. Portions 202, 204, and 206 are performed by circuit protection devices 102, 104, and 106, respectively. Portion 208 is performed by ZSI module 135.

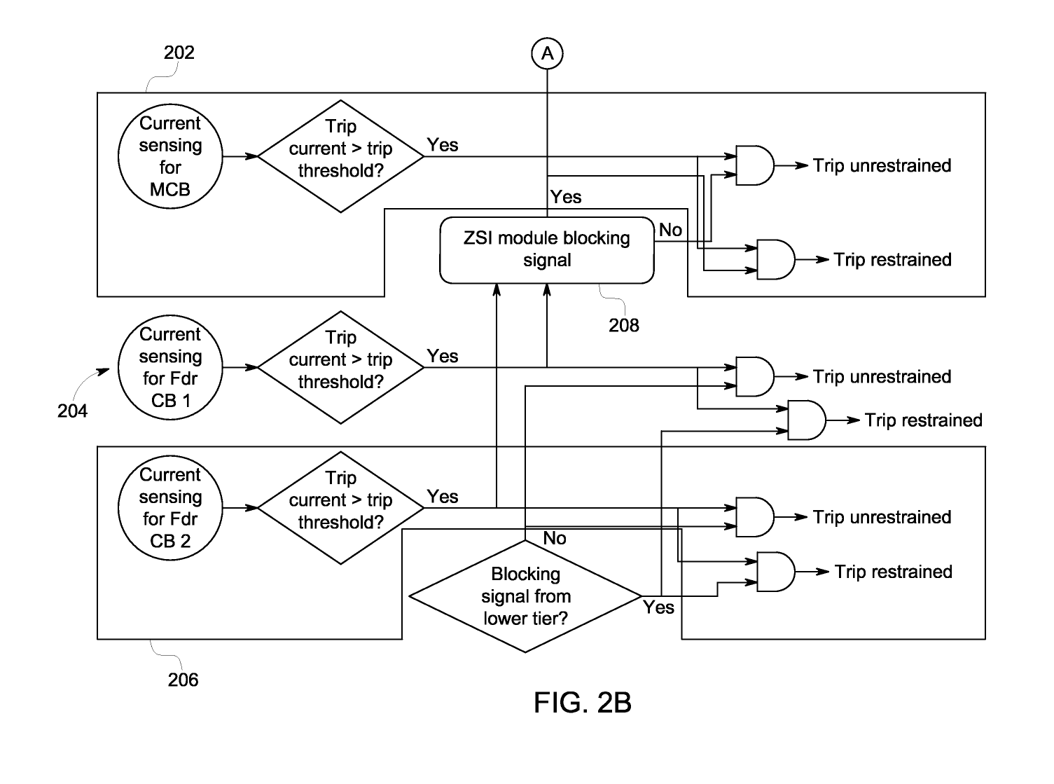

FIG. 3 is a simplified block diagram of one embodiment of AFRS 136. In this embodiment, AFRS 136 includes an arc flash relay 300. Arc flash relay 300 receives the current signals from current sensor 140 via input 302, receives the detection signals from arc flash sensors 138 via input 304, and receives the blocking signals from circuit protection devices 102, 104, and 106 via input 306. In the exemplary embodiment, arc flash relay 300 is configured to perform all of the functions of AFRS 136 as described above. More specifically, arc flash relay 300 includes a controller 308 configured to determine that an arc flash has occurred based on the detection signal. Controller 308 is configured to activate circuit protection device 142 in response to the suspected arc flash when controller 308 is not receiving a blocking signal and delay activation of circuit protection device 142 when controller 308 is receiving the blocking signal. Moreover, if AFRS 136 is operating in maintenance mode, activation of circuit protection device 142 is not delayed by a blocking signal. Controller 308 activates circuit protection device 142 by outputting a trip signal to circuit protection device 142 through output 310. In the exemplary embodiment, controller 308 includes a processor 312 and a memory device 314 coupled to the processor. In other embodiments controller 308 is an analog controller, a combination of an analog and a digital controller, or any other suitable type of controller. In other embodiments, arc flash relay 300 may be any other suitable arc flash relay capable of operating as described herein. Moreover, in some embodiments, the actions described herein as performed by AFRS 136 and/or arc flash 300 may be divided among multiple components.

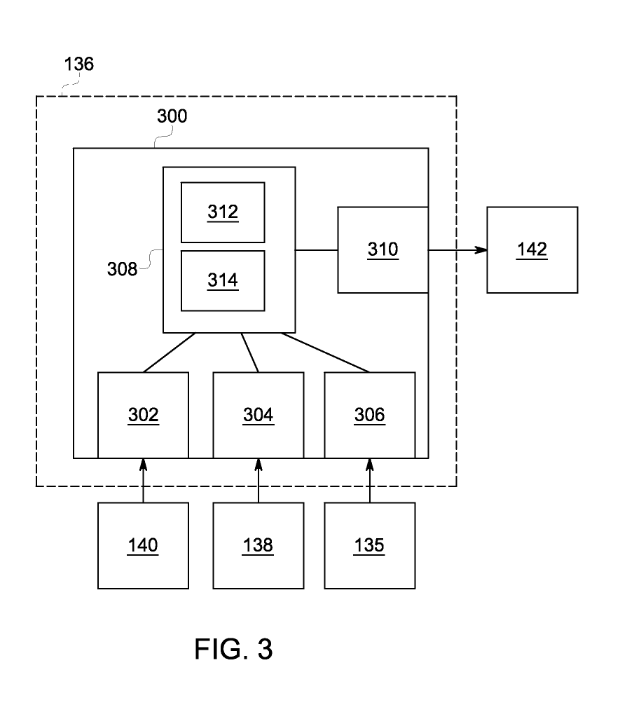

FIG. 4 is a simplified block diagram of another embodiment of AFRS 136. In this embodiment, AFRS 136 includes an arc flash relay 400 coupled to external blocking logic 402. Arc flash relay 400 receives the current signals from current sensor 140 via input 404 and receives the detection signals from arc flash sensors 138 via input 406. In this embodiment, arc flash relay 400 outputs two signals. The first output signal indicates whether or not the received detection signal indicates an arc flash, and the second output signal indicates whether or not the received current signal exceeds a threshold value. In this embodiment, arc flash relay 400 neither receives nor considers any blocking signals. Blocking logic 402 receives the two output signals from arc flash relay 400 and any blocking signals from circuit protection devices 102, 104, and 106. Blocking logic 402 is configured to activate circuit protection device 142 in response to the first output indicating the detection of an arc flash, the second output signal indicating the current exceeds the threshold, and no blocking signal having been received. Except when AFRS 136 is in the maintenance mode, blocking logic 402 is configured to delay activation of circuit protection device 142 when the first output indicating the detection of an arc flash, the second output signal indicating the current exceeds the threshold, and it is receiving the blocking signal. Blocking logic 402 activates circuit protection device 142 by outputting a trip signal to circuit protection device 142. Blocking logic 402 may be discrete logic gates, may be implemented in a controller separate from arc flash relay 400, and or may be implemented in any other suitable device.

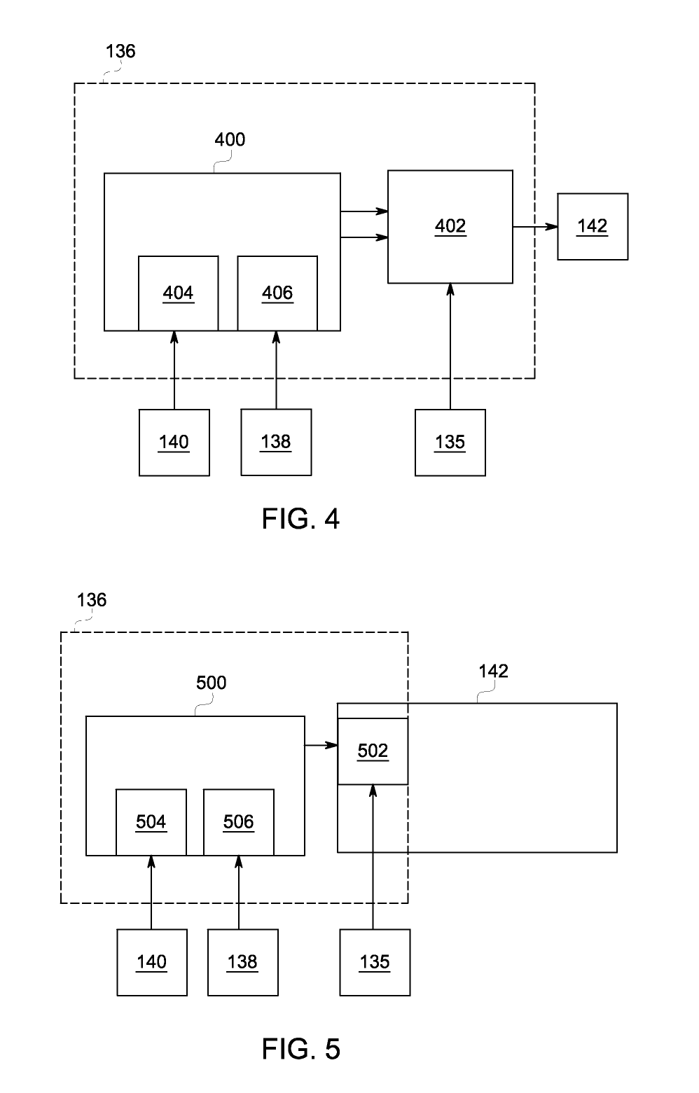

FIG. 5 is a simplified block diagram of a third embodiment of AFRS 136. In this embodiment, AFRS 136 includes an arc flash relay 500 and a controller 502 for circuit protection device 142. Arc flash relay 500 receives the current signals from current sensor 140 via input 504 and receives the detection signals from arc flash sensors 138 via input 506. As described above with respect to AFRS 136, arc flash relay 500 is configured to determine that an arc flash has occurred based, at least in part, on the detection signal. In this embodiment, arc flash relay 500 neither receives nor considers any blocking signals. Upon determining an arc flash has occurred, arc flash relay 500 outputs a trip signal. In the exemplary embodiment, arc flash relay is configured to output one of two different trip signals. A first trip signal indicates a suspected arc flash, and a second trip signal indicates a suspected arc flash when AFRS 136 is operating in maintenance mode. Controller 502 receives the trip signal from arc flash relay 500 and any blocking signals from circuit protection devices 102, 104, and 106. Controller 502 is configured to activate circuit protection device 142 (e.g. activate the arc containment device, trip a tripping mechanism 124, trigger the crowbar, etc.) in response to the trip signal when controller 502 is not receiving a blocking signal and to delay activation of circuit protection device 142 when it is receiving the blocking signal. Controller 502 may be any suitable analog controller, digital controller, or combination of analog and digital controls.

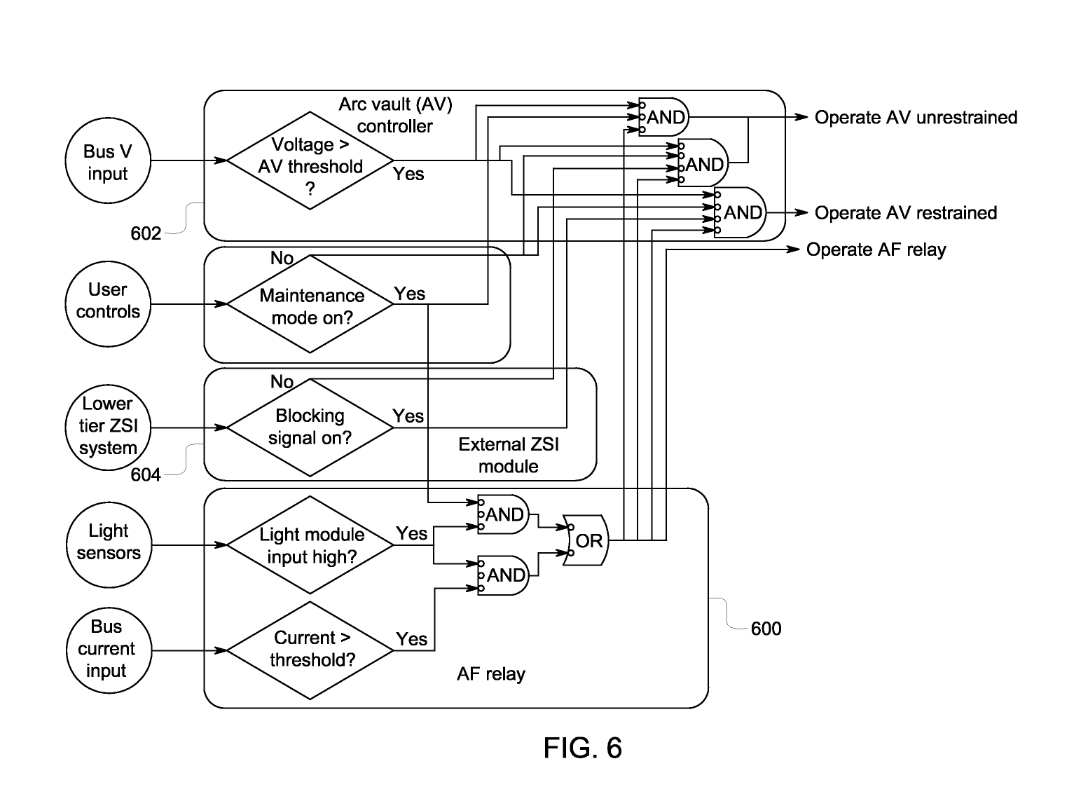

FIG. 6 is an exemplary logical flow diagram for some embodiments of AFRS 136 as shown in FIG. 5. Other embodiments may include different logical inputs, outputs, and/or operations. In the exemplary embodiments, portion 600 is performed by arc flash relay 500, portion 602 is performed by controller 502, portion 604 is performed by ZSI controller 135. Controller 502 determines whether to activate circuit protection device 142 when an arc flash is detected by arc flash relay 500 or to delay activation of circuit protection device 142 because a blocking signal is present. In this embodiment, the determination is also based on whether or not an input bus voltage, e.g. a voltage on main bus 114 exceeds a threshold for activation of circuit protection device 142. In this embodiment, arc flash relay 500 operates a circuit protection device, such as circuit protection device 102, upon determining that an arc flash has occurred.

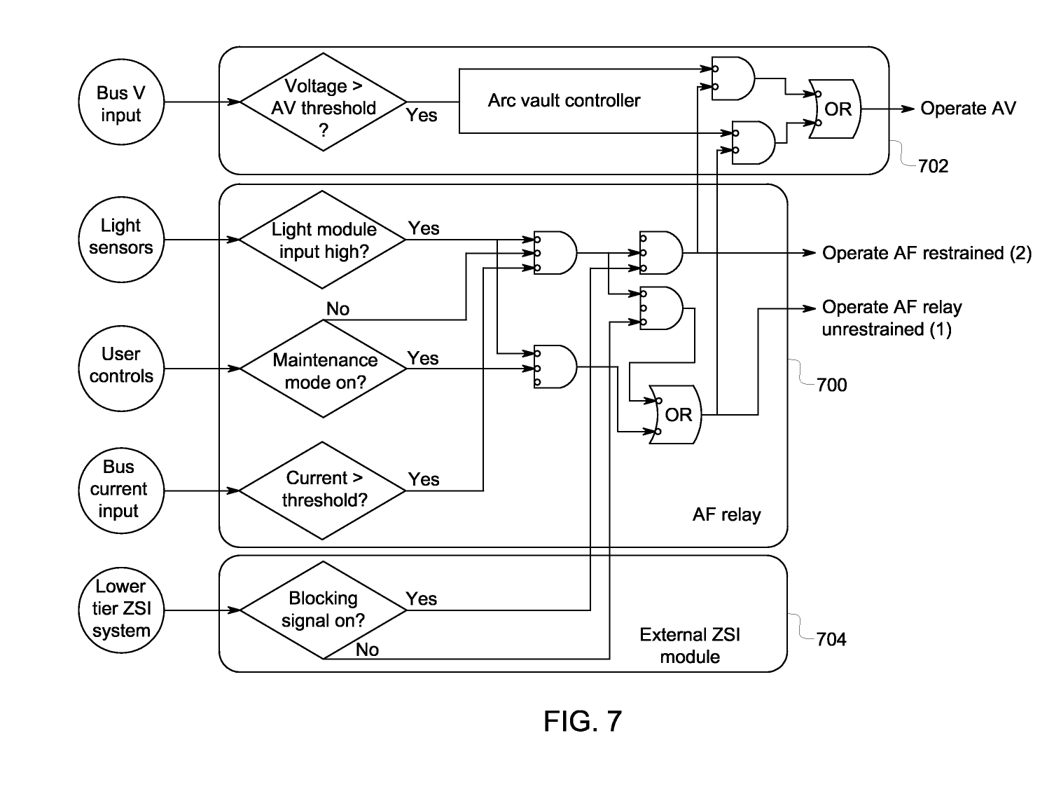

FIG. 7 is another exemplary logical flow diagram for some embodiments of AFRS 136 as shown in FIG. 5. Portion 700 is performed by arc flash relay 500, portion 702 is performed by controller 502, and portion 604 is performed by ZSI controller 135. Controller 502 does not receive the blocking signals in this embodiment. Instead, arc flash relay 500 receives the blocking signals. In this embodiment, arc flash relay 500 also operates a circuit protection device, such as circuit protection device 102, upon determining that an arc flash has occurred. Arc flash relay 500 operates circuit protection device 102 according to an unrestrained mode if a blocking signal has not been received and operates it according to a restrained mode if a blocking signal has been received.

A technical effect of the methods and systems described herein may include one or more of: (a) determining that an arc flash has occurred within a volume occupied by a power distribution system; (b) activating a second circuit protection device configured to provide arc flash protection in response to the determination that an arc flash has occurred when a blocking signal is not received from a first circuit protection device; (c) delaying activation of a second circuit protection device configured to provide arc flash protection in response to the determination that an arc flash has occurred when a blocking signal is received from a first circuit protection device.

Exemplary embodiments of power distribution systems and methods of operating a power distribution system are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the power system as described herein.

The order of execution or performance of the operations in the embodiments are illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of this disclosure.

Although specific features of various embodiments of the may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A power distribution system comprising:
a first distribution bus operatively disposed within a cavity defined by an enclosure;
an arc flash sensor configured to detect an arc within the cavity and generate a detection signal;
an arc flash relay system communicatively coupled to said arc flash sensor, said arc flash relay system comprising a controller configured to determine an arc flash has occurred based, at least in part, on the detection signal; and
a first circuit protection device disposed within the cavity, said first circuit protection device comprising:
a trip mechanism configured to interrupt a current flowing through said first distribution bus; and
a trip unit operatively coupled to said trip mechanism, said trip unit configured to:
determine when a current on said first distribution bus exceeds a protection threshold; and
output a blocking signal to said arc flash relay system and output a trip signal to said trip mechanism upon determining that a current on said first distribution bus exceeds the protection threshold.

2. A power distribution system in accordance with claim 1, further comprising a second circuit protection device, and wherein said arc flash relay system is configured to output a trip signal to activate said second circuit protection device in response to determining an arc flash has occurred.

3. A power distribution system in accordance with claim 2, wherein said second circuit protection device comprises an arc flash mitigation device.

4. A power distribution system in accordance with claim 2, further comprising a second distribution bus configured to provide electrical power to at least said first circuit protection device, and wherein said second circuit protection device comprises a circuit breaker configured to interrupt a current flowing through said second distribution bus in response to the trip signal from said arc flash relay system.

5. A power distribution system in accordance with claim 2, wherein said arc flash system is further configured to operate in a restrained mode in response to the blocking signal from said first circuit protection device trip unit.

6. A power distribution system in accordance with claim 5, wherein operating in the restrained mode comprises delaying the output of the trip signal to activate said second circuit protection device for a determined period of time after determining that an arc flash has occurred.

7. A power distribution system in accordance with claim 6, wherein the determined period of time is greater than a length of time required for said first circuit protection device trip mechanism to interrupt the current flowing through said first distribution bus in response to the trip signal from said first circuit protection device trip unit.

8. A power distribution system in accordance with claim 5, wherein said arc flash relay is operable in a normal mode and a maintenance mode, and wherein said arc flash relay is configured to ignore the blocking signal when said arc flash relay is operating in a maintenance mode.

9. A power distribution system in accordance with claim 1, wherein said arc flash sensor comprises at least one of a light sensor, a sound sensor, and a pressure sensor.

10. An arc flash relay system for use in a power distribution system including an arc flash sensor, a first circuit protection device, and a second circuit protection device, said arc flash relay system comprising:
a first input configured to receive a detection signal from the arc flash sensor;
a second input configured to receive a blocking signal from the first circuit protection device; and
a controller configured to:
determine an arc flash has occurred based, at least in part, on the detection signal;
activate the second circuit protection device in response to the determination that an arc flash has occurred when said controller is not receiving the blocking signal; and
delay activation of the second circuit protection device in response to the determination that an arc flash has occurred when said controller is receiving the blocking signal.

11. An arc flash relay system in accordance with claim 10, wherein said controller is configured to delay activation of the second circuit protection device for a determined time greater than a length of time for the first circuit protection device to act to protect the first load.

12. An arc flash relay system in accordance with claim 10, further comprising a third input configured to receive a current signal from a current sensor, and wherein said controller is configured to determine that an arc flash has occurred based on the detection signal and the current signal.

13. An arc flash relay system in accordance with claim 10, wherein said controller is selectively operable in a normal mode and a maintenance mode, and wherein said controller is configured to delay activation of the second circuit protection device in response to the determination that an arc flash has occurred when said controller is operating in the normal mode and receiving the blocking signal, and to activate the second circuit protection device, regardless of the blocking signal, in response to the determination that an arc flash has occurred when said controller is operating in the maintenance mode.

14. An arc flash relay system in accordance with claim 10, wherein said controller is configured to delay activation of the second circuit protection device for as long as said controller is receiving the blocking signal.

15. A method for use by an arc flash relay system in a power distribution system including a first circuit protection device configured to output a blocking signal, and a second circuit protection device configured to provide arc flash protection, said method comprising:
determining an arc flash has occurred within a cavity occupied by the power distribution system;
activating the second circuit protection device in response to the determination that an arc flash has occurred when the arc flash relay system is not receiving the blocking signal from the first circuit protection device; and
delaying activation of the second circuit protection device in response to the determination that an arc flash has occurred when the arc flash relay system is receiving the blocking signal from the first circuit protection device.

16. A method in accordance with claim 15, wherein delaying activation of the second circuit protection device comprises delaying activation of the second circuit protection device for a determined time greater than a length of time for the first circuit protection device to act to protect the load.

17. A method in accordance with claim 15, further comprising receiving a signal from an arc flash sensor positioned within the cavity occupied by the power distribution system and wherein determining that an arc flash has occurred within a cavity occupied by the power distribution system comprises determining that an arc flash has occurred within a cavity occupied by the power distribution system based, at least in part, on the received signal from the arc flash sensor.

18. A method in accordance with claim 15, wherein said arc flash relay system is selectively operable in a normal mode and a maintenance mode, and wherein delaying activation of the second circuit protection device comprises delaying activation of the second circuit protection device when said controller is operating in the normal mode and receiving the blocking signal.

19. A method in accordance with claim 18, wherein activating a second circuit protection device further comprises activating a second circuit protection device, regardless of the blocking signal, in response to the determination that an arc flash has occurred when the arc flash relay system is operating in the maintenance mode.

20. A method in accordance with claim 15, wherein delaying activation of the second circuit protection device comprises delaying activation of the second circuit protection device for as long as the arc flash relay system is receiving the blocking signal.
